(19) United States
(12) Patent Application Publication
(10) Pub. No.: US 2025/0316687 A1
(43) Pub. Date: Oct. 9, 2025

(54) ACTIVE MATERIAL FOR NEGATIVE ELECTRODE AND SODIUM ION BATTERY

(71) Applicant: Industrial Technology Research Institute, Hsinchu (TW)

(72) Inventors: Chun-Chi Tseng, New Taipei City (TW); Chia-Erh Liu, Hsinchu County (TW); Yu-Hao Huang, Kaohsiung City (TW); Kuan-Yu Chen, Taichung City (TW)

(73) Assignee: Industrial Technology Research Institute, Hsinchu (TW)

(21) Appl. No.: 19/068,013

(22) Filed: Mar. 3, 2025

Related U.S. Application Data
(60) Provisional application No. 63/573,500, filed on Apr. 3, 2024.

(30) Foreign Application Priority Data
Dec. 12, 2024 (TW) 113148508

(51) Int. Cl. H01M 4/36; H01M 4/02; H01M 4/485; H01M 4/587; H01M 10/054; H01M 10/0568

(52) U.S. Cl. CPC H01M 4/366; H01M 4/485; H01M 4/587; H01M 10/054; H01M 10/0568; H01M 2004/027; H01M 2300/0025

(57) ABSTRACT

An active material for negative electrode and a sodium ion battery are provided. The active material for negative electrode includes a core material and a first ion-conducting modification layer. The core material is a carbon material. The first ion-conducting modification layer is disposed on a surface of the core material. A material of the first ion-conducting modification layer includes sodium titanium oxide.

### CROSS-REFERENCE TO RELATED APPLICATION

This application claims the priority benefit of U.S. Provisional Application No. 63/573,500, filed on Apr. 3, 2024 and Taiwan Application No. 113148508, filed on Dec. 12, 2024. The entirety of each of the above-mentioned patent applications is hereby incorporated by reference herein and made a part of this specification.

### TECHNICAL FIELD

The disclosure relates to an active material and a battery, and in particular to an active material for negative electrode and a sodium ion battery.

### BACKGROUND

In recent years, with the increasing demand for energy storage batteries, sodium-ion batteries with low cost and high safety have attracted increasing attention. However, during the charging/discharging process of the sodium ion battery, sodium ions are easily consumed by the side reaction of forming the solid electrolyte interface (SEI), resulting in a sharp decline in battery life, and the thickened SEI layer causes the internal impedance of the battery to continue to rise, which will affect the electrical performance of the battery.

### SUMMARY

An active material for negative electrode of the disclosure includes a core material and a first ion-conducting modification layer. The core material is a carbon material. The first ion-conducting modification layer is disposed on a surface of the core material. A material of the first ion-conducting modification layer includes sodium titanium oxide.

A sodium ion battery of the disclosure includes a negative electrode plate. The negative electrode plate includes the active material for negative electrode.

Several exemplary embodiments accompanied with drawings are described in detail below to further describe the disclosure in detail.

### BRIEF DESCRIPTION OF THE DRAWINGS

The accompanying drawings are included to provide a further understanding, and are incorporated in and constitute a part of this specification. The drawings illustrate exemplary embodiments and, together with the description, serve to explain the principles of the disclosure.

FIG. 1A is a schematic cross-sectional view of an active material for negative electrode according to an embodiment of the disclosure.

FIG. 1B is a schematic cross-sectional view of an active material for negative electrode according to another embodiment of the disclosure.

FIG. 1C is a schematic cross-sectional view of an active material for negative electrode according to another embodiment of the disclosure.

FIG. 2A is a schematic cross-sectional view of an active material for negative electrode according to another embodiment of the disclosure.

FIG. 2B is a schematic cross-sectional view of an active material for negative electrode according to another embodiment of the disclosure.

FIG. 2C is a schematic cross-sectional view of an active material for negative electrode according to another embodiment of the disclosure.

FIG. 3 is a schematic view of a sodium ion battery according to an embodiment of the disclosure.

### DETAILED DESCRIPTION OF DISCLOSURED EMBODIMENTS

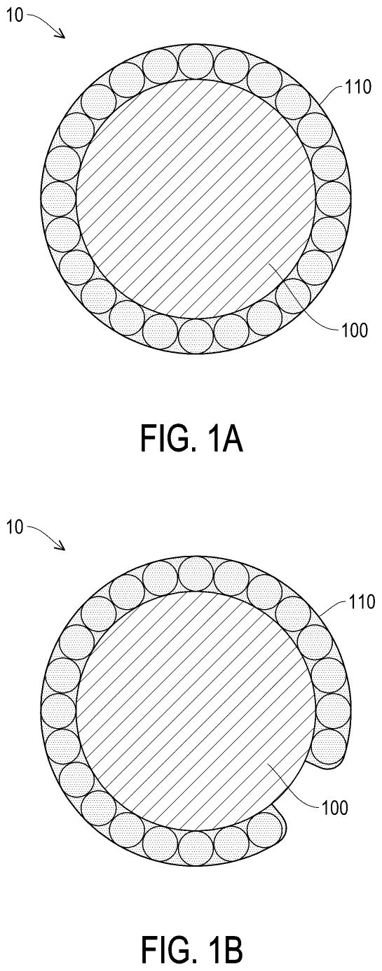

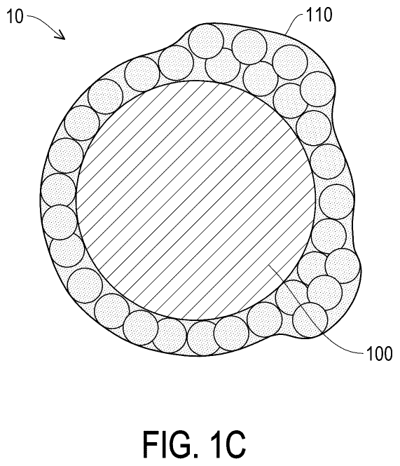

FIG. 1A is a schematic cross-sectional view of an active material for negative electrode according to an embodiment of the disclosure. FIG. 1B is a schematic cross-sectional view of an active material for negative electrode according to another embodiment of the disclosure. FIG. 1C is a schematic cross-sectional view of an active material for negative electrode according to another embodiment of the disclosure.

Please refer to FIG. 1A to FIG. 1C. An active material for negative electrode 10 includes a core material 100 and a first ion-conducting modification layer 110. The core material 100 is a carbon material. In some embodiments, the carbon material includes hard carbon, soft carbon, or other suitable carbon materials. The first ion-conducting modification layer 110 is disposed on a surface of the core material 100. The first ion-conducting modification layer 110 has the characteristics of conducting sodium ions and storing sodium ions. For example, a material of the first ion-conducting modification layer 110 may include sodium titanium oxide. In some embodiments, the sodium titanium oxide includes sodium titanate or other suitable sodium titanium oxides.

In some embodiments, the first ion-conducting modification layer 110 may be formed on the surface of the core material 100 through a sol-gel method and is in direct contact with the core material 100. For example, a sodium-containing precursor and a titanium-containing precursor may be respectively mixed with a solvent to form a sodium-containing precursor solution and a titanium-containing precursor solution. In some embodiments, the sodium-containing precursor may include sodium acetate, sodium hydroxide, sodium ethoxide, or the like. In some embodiments, the titanium-containing precursor may include butyl titanate (Ti(Obu)₄, TBT), isopropyl titanate (Ti(OPr)₄, TTIP), or the like. In some embodiments, the solvent may include ethanol or other suitable solvents. In some embodiments, the sodium-containing precursor solution may further include a catalyst. The catalyst is, for example, water. Afterwards, the core material 100 is added to the titanium-containing precursor solution and uniformly stirred to form a first mixed solution. Next, the sodium-containing precursor solution is added to the first mixed solution to form a second mixed solution. The second mixed solution is then heated to remove the solvent. After that, high-temperature calcination is performed to form the sodium titanium oxide on the surface of the core material 100 to obtain the active material for negative electrode 10. In some embodiments, the temperature of the high-temperature calcination may be between 600° C. and 900° C., and the time of the high-temperature calcination may be between 3 hours and 8 hours, but the disclosure is not limited thereto.

In some embodiments, the first ion-conducting modification layer 110 is a layer formed by stacking sodium titanium oxide particles, so the surface of the active material for negative electrode 10 may have an uneven appearance. FIG. 1A to FIG. 1C schematically illustrate multiple circles in the first ion-conducting modification layer 110 to represent the sodium titanium oxide particles, but are not intended to limit the disclosure. It should be understood that the sodium titanium oxide particles may have different shapes and sizes and are stacked on each other to form the first ion-conducting modification layer 110.

In some embodiments, the sodium titanium oxide particles may be uniformly or non-uniformly formed on the surface of the core material 100, so that the first ion-conducting modification layer 110 has a uniform or non-uniform thickness. In the disclosure, a layer with a uniform thickness means that a difference (that is, |T−Tav|) between a thickness (T) of the layer at each place and an average thickness (Tav) of the layer is less than or equal to one standard deviation of the thickness of the layer; and a layer with a non-uniform thickness means that the difference (that is, |T−Tav|) between the thickness (T) of at least one place of the layer and the average thickness (Tav) of the layer is greater than one standard deviation of the thickness of the layer.

In some embodiments, as shown in FIG. 1A, the sodium titanium oxide particles are substantially uniformly formed on the surface of the core material 100, so that the first ion-conducting modification layer 110 completely covers the surface of the core material 100 and has a substantially uniform thickness. In other words, the first ion-conducting modification layer 110 may be a continuous layer with a uniform thickness.

In some embodiments, as shown in FIG. 1B, the sodium titanium oxide particles partially cover the surface of the core material 100, so that the first ion-conducting modification layer 110 is formed as a discontinuous layer on the surface of the core material 100, and a part of the surface of the core material 100 is not covered by the first ion-conducting modification layer 110 and is exposed. In the embodiment, the first ion-conducting modification layer 110 may have a uniform or non-uniform thickness, but the disclosure is not limited thereto.

In some embodiments, as shown in FIG. 1C, the sodium titanium oxide particles completely cover the surface of the core material 100 and have a thicker thickness in local regions, so that the first ion-conducting modification layer 110 is formed as a continuous layer with a non-uniform thickness.

In some embodiments, the average particle size of the core material 100 is between 1 μm and 25 μm, but the disclosure is not limited thereto.

In some embodiments, the coverage of the first ion-conducting modification layer 110 on the core material 100 is more than 80%, so that when the active material for negative electrode 10 is subsequently applied to a sodium ion battery, the core material 100 may be isolated from an electrolyte, or direct contact between the core material 100 and the electrolyte may be reduced, thereby reducing consumption of sodium ions in the electrolyte.

In some embodiments, a weight ratio of the core material 100 to the first ion-conducting modification layer 110 may be between 100:0.5 and 100:5. On the basis that a material content of the core material 100 is 100 parts by weight, when a material content of the first ion-conducting modification layer 110 is too small, for example, less than 0.5 parts by weight, it is not conducive for the first ion-conducting modification layer 110 to unleash the characteristic of conducting sodium ions or storing sodium ions, and it is also difficult to effectively isolate the core material 100 from the electrolyte; and when the material content of the first ion-conducting modification layer 110 is too much, for example, more than 5 parts by weight, the capacitance per unit weight of the active material for negative electrode 10 may be reduced.

Since the active material for negative electrode 10 has the first ion-conducting modification layer 110 disposed on the surface of the core material 100, diffusion of the sodium ions on the core material 100 may be promoted, and the core material 100 may be isolated from the electrolyte, so that when the active material for negative electrode 10 is subsequently applied to a negative electrode of the sodium ion battery, a side reaction of forming a solid electrolyte interface (SEI) during a charging/discharging process is reduced and the consumption of the sodium ions in the electrolyte is reduced.

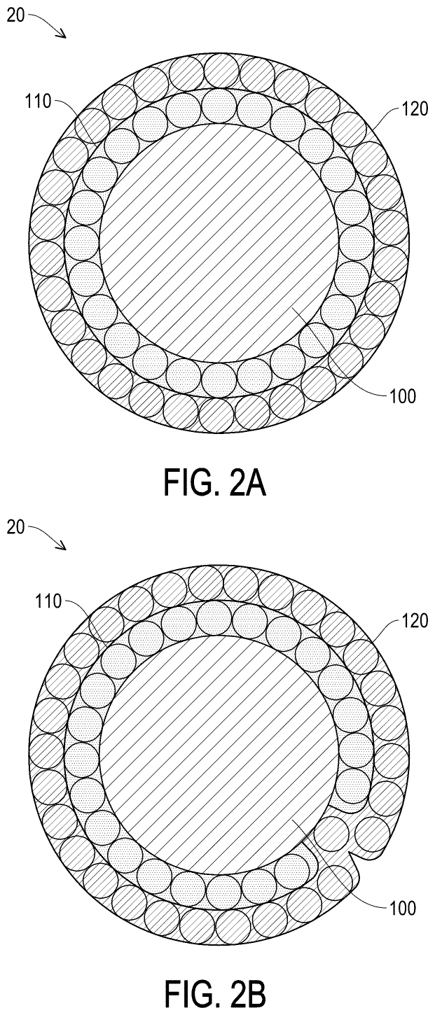

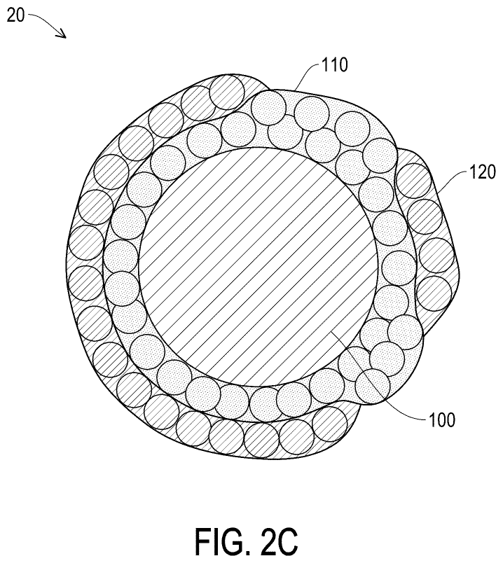

FIG. 2A is a schematic cross-sectional view of an active material for negative electrode according to another embodiment of the disclosure. FIG. 2B is a schematic cross-sectional view of an active material for negative electrode according to another embodiment of the disclosure. FIG. 2C is a schematic cross-sectional view of an active material for negative electrode according to another embodiment of the disclosure. FIG. 2A to FIG. 2C continue to use the reference numerals and some content of the embodiment of FIG. 1A to FIG. 1C, wherein the same or similar numerals are used to represent the same or similar elements, and the description of the same technical content is omitted. For the description of the omitted part, reference may be made to the foregoing embodiment, which will not be described again here.

Please refer to FIG. 2A to FIG. 2C. The main difference between the embodiment of FIG. 2A to FIG. 2C and the embodiment of FIG. 1A to FIG. 1C is that an active material for negative electrode 20 of the embodiment of FIG. 2A to FIG. 2C further includes a second ion-conducting modification layer 120, and the second ion-conducting modification layer 120 is disposed on a surface of the first ion-conducting modification layer 110. In some embodiments, the ability of the second ion-conducting modification layer 120 to conduct sodium ions may be better than that of the first ion-conducting modification layer 110. In some embodiments, a material of the second ion-conducting modification layer 120 may include lithium titanium oxide. In some embodiments, the lithium titanium oxide includes lithium titanate or other suitable lithium titanium oxides.

In some embodiments, the second ion-conducting modification layer 120 may be formed on the surface of the first ion-conducting modification layer 110 through a sol-gel method and is in direct contact with the first ion-conducting modification layer 110. For example, a lithium-containing precursor and a titanium-containing precursor may be respectively mixed with a solvent to form a lithium-containing precursor solution and a titanium-containing precursor solution. In some embodiments, the lithium-containing precursor may include lithium acetate, lithium hydroxide, lithium methoxide, or the like. In some embodiments, the titanium-containing precursor may include butyl titanate (Ti(Obu)₄, TBT), isopropyl titanate (Ti(OPr)₄, TTIP), or the like. In some embodiments, the solvent may include ethanol or other suitable solvents. In some embodiments, the lithium-containing precursor solution may further include a catalyst. The catalyst is, for example, water. After that, the core material 100 (for example, the active material for negative electrode 10) with the surface formed with the first ion-conducting modification layer 110 is added to the titanium-containing precursor solution and uniformly stirred to form a third mixed solution. Next, the lithium-containing precursor solution is added to the third mixed solution to form a fourth mixed solution. The fourth mixed solution is then heated to remove the solvent. After that, high-temperature calcination is performed to form the lithium titanium oxide on the surface of the first ion-conducting modification layer 110 to obtain the active material for negative electrode 20. In some embodiments, the temperature of the high-temperature calcination may be between 600° C. and 900° C., and the time of the high-temperature calcination may be between 3 hours and 8 hours, but the disclosure is not limited thereto.

In some embodiments, the second ion-conducting modification layer 120 is a layer mainly formed by stacking lithium titanium oxide particles, so the surface of the active material for negative electrode 20 may have an uneven appearance. FIG. 2A to FIG. 2C schematically illustrate multiple circles in the second ion-conducting modification layer 120 to represent the lithium titanium oxide particles, but are not intended to limit the disclosure. It should be understood that the lithium titanium oxide particles may have different shapes and sizes and are stacked on each other to form the second ion-conducting modification layer 120. In some embodiments, the lithium titanium oxide particles may be uniformly or non-uniformly formed on the surface of the first ion-conducting modification layer 110, so that the second ion-conducting modification layer 120 has a uniform or non-uniform thickness.

In some embodiments, as shown in FIG. 2A, the lithium titanium oxide particles are substantially uniformly formed on the surface of the first ion-conducting modification layer 110 as shown in FIG. 1A, so that the second ion-conducting modification layer 120 completely covers the surface of the first ion-conducting modification layer 110 and has a substantially uniform thickness. In other words, the second ion-conducting modification layer 120 may be a continuous layer with a uniform thickness.

In some embodiments, as shown in FIG. 2B, the lithium titanium oxide particles are formed on the surface of the first ion-conducting modification layer 110 as shown in FIG. 1B, and since the first ion-conducting modification layer 110 of FIG. 1B is a discontinuous layer, in addition to the lithium titanium oxide particles precipitating on the surface of the first ion-conducting modification layer 110, a part of the lithium titanium oxide particles may also precipitate on a small part of the surface of the core material 100 not covered by the first ion-conducting modification layer 110. In the embodiment, the second ion-conducting modification layer 120 may have a uniform or non-uniform thickness, but the disclosure is not limited thereto.

In some embodiments, as shown in FIG. 2C, the lithium titanium oxide particles are formed on the surface of the first ion-conducting modification layer 110 as shown in FIG. 1C and partially cover the surface of the first ion-conducting modification layer 110, so that a part of the first ion-conducting modification layer 110 is not covered by the second ion-conducting modification layer 120 and is exposed. In other words, the second ion-conducting modification layer 120 is formed as a discontinuous layer on the surface of the first ion-conducting modification layer 110. In the embodiment, the second ion-conducting modification layer 120 may have a uniform or non-uniform thickness, but the disclosure is not limited thereto.

In some embodiments, on the basis that the material content of the core material 100 is 100 parts by weight, a material content of the second ion-conducting modification layer 120 may be less than or equal to 5 parts by weight, so that when the active material for negative electrode 20 is applied to the negative electrode of the sodium ion battery, conduction of sodium ions is further improved. In some embodiments, a weight ratio of the core material 100 to the second ion-conducting modification layer 120 may be between 100:0.5 and 100:5.

Since the active material for negative electrode 20 has the second ion-conducting modification layer 120 disposed on the surface of the first ion-conducting modification layer 110, and the first ion-conducting modification layer 110 is disposed on the surface of the core material 100, the diffusion of the sodium ions on the core material 100 may be improved, and the core material 100 may be isolated from the electrolyte, so that when the active material for negative electrode 20 is subsequently applied to the negative electrode of the sodium ion battery, the side reaction of forming the solid electrolyte interface (SEI) during the charging/discharging process is reduced and the consumption of the sodium ions in the electrolyte is reduced.

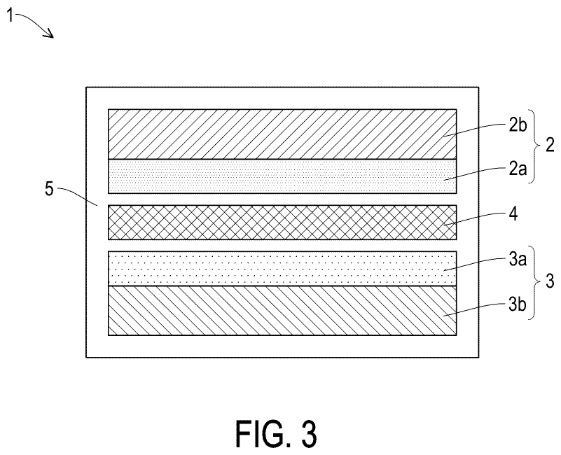

FIG. 3 is a schematic view of a sodium ion battery according to an embodiment of the disclosure.

Please refer to FIG. 3. A sodium ion battery 1 includes a negative electrode plate 2, a positive electrode plate 3, a separator 4, and a liquid electrolyte 5. The negative electrode plate 2, the positive electrode plate 3, and the separator 4 are disposed in the liquid electrolyte 5, and the separator 4 is located between the negative electrode plate 2 and the positive electrode plate 3, so the liquid electrolyte 5 is filled between the separator 4 and the negative electrode plate 2 and between the separator 4 and the positive electrode plate 3, and separates the negative electrode plate 2 from the positive electrode plate 3 through the separator 4 and allows ions to pass through.

In some embodiments, the negative electrode plate 2 includes an active material for negative electrode 2a and a negative electrode current collector 2b, and the active material for negative electrode 2a is coated on a surface of the negative electrode current collector 2b. In some embodiments, the active material for negative electrode 2a may, for example, be the active material for negative electrode 10 or the active material for negative electrode 20. In some embodiments, a material of the negative electrode current collector 2b may include copper, aluminum, or other suitable metals.

In some embodiments, the positive electrode plate 3 includes an active material for positive electrode 3a and a positive electrode current collector 3b, and the active material for positive electrode 3a is coated on a surface of the positive electrode current collector 3b. The active material for positive electrode 3a of the positive electrode plate 3 and the active material for negative electrode 2a of the negative electrode plate 2 are disposed facing each other. In some embodiments, the active material for positive electrode 3a may include a layered metal oxide material, a Prussian blue (PB) series derivative, a natrium superionic conductor (NASICON, also known as a polyanionic compound), or a combination thereof, but not limited thereto. In some embodiments, a material of the positive current collector 3b may include copper, aluminum, or other suitable metals.

In some embodiments, a material of the separator 4 includes glass fiber, a polymer material, a ceramic material, or a combination thereof, but the disclosure is not limited thereto. The polymer material includes, for example, cellulose, polypropylene (PP), polyethylene (PE), a combination thereof, or other suitable polymer materials, but the disclosure is not limited thereto.

In some embodiments, the liquid electrolyte 5 includes a solvent and a salt. The solvent may include ethylene carbonate (EC), diethyl carbonate (DEC), propylene carbonate (PC), ethyl methyl carbonate (EMC), dimethyl carbonate (DMC), diethylene glycol dimethyl ether (DME), or a combination thereof, but the disclosure is not limited thereto. The salt may include sodium perchlorate (NaClO₄), sodium fluoroborate (NaBF₄), sodium hexafluorophosphate (NaPF₆), sodium triflate (NaCF₃SO₃), sodium bis(fluorosulfonyl)imide (Na(FSO₂)₂N), sodium bistrifluoromethylsulfonimide (Na(CF₃SO₂)₂N), sodium difluorooxalate borate (NaODFB), sodium 4,5-dicyano-2-(trifluoromethyl)imidazolate (NaTDI), sodium 4,5-dicyano-2-(pentafluoroethyl)imidazolate (NaPDI), sodium bisoxalate borate (NaBOB), sodium bis[salicylato (2-)]-borate (NaBSB), sodium salicylic benzylic acid borate (NaBDSB), sodium tetraphenyl borate (NaBPh₄), or a combination thereof, but the disclosure is not limited thereto.

In some embodiments, the liquid electrolyte 5 may also include an additive to form a more stable solid electrolyte interface (SEI), a flame retardant, improve performance in high and low temperature environments, prevent battery overcharging, protect the positive electrode, etc. In some embodiments, the additive may include vinylene carbonate (VC), fluoroethylene carbonate (FEC), propylene-1,3-sulfolactone (PST), vinyl sulfate (DTD), sodium difluorooxalate borate (NaODFB), trimethyl phosphate (TMP), triethyl phosphate (TEP), triphenyl phosphate (TPP), tributyl phosphate (TBP), dimethyl methyl phosphate (DMMP), tris(2,2,2-trifluoroethyl) phosphate (TEEP), ethoxy(pentafluoro)cyclotriphosphonitrile (EFPN), methyl nonafluorobutyl ether (MFE), perfluorinated (2-methyl-3-pentanone (PFMP), 1,1,2,2-tetrafluoroethyl-2,2,3,3-tetrafluoropropyl ether (HFE), or biphenyl (BP), but the disclosure is not limited thereto.

Since the active material for negative electrode 2a of the sodium ion battery 1 has the first ion-conducting modification layer 110 and/or the second ion-conducting modification layer 120 disposed on the surface of the core material 100, the diffusion of the sodium ions on the core material 100 can be promoted, while isolating the liquid electrolyte 5 from the core material 100. Therefore, the side reaction of forming the solid electrolyte interface (SEI) during the charging/discharging process may be reduced and the consumption of the sodium ions in the electrolyte may be reduced, thereby improving the cycle life of the sodium ion battery 1.

Hereinafter, a preparation method of the active material for negative electrode of the disclosure will be described in detail through experimental examples. However, the following experimental examples are not intended to limit the disclosure.

### Example 1

0.571 g of sodium acetate was dissolved in 15 ml of alcohol and 0.716 g of water was added to form a sodium-containing precursor solution. In addition, 3.382 g of butyl titanate was dissolved in 15 ml of alcohol to form a titanium-containing precursor solution. 20 g of hard carbon (a core material with an average particle size of approximately 10 μm) was added to the titanium-containing precursor solution and uniformly stirred to form a first mixed solution. Then, the sodium-containing precursor solution was added to the first mixed solution and uniformly stirred to form a second mixed solution. Then, a solvent of the second mixed solution was removed by heating to obtain powder. Finally, the obtained powder was heated to 800° C. and calcined in an inert gas and kept at the temperature for 5 hours to obtain an active material for negative electrode (similar to as shown in FIG. 1A to FIG. 1C) with a hard carbon surface coated with sodium titanate (that is, a first ion-conducting modification layer), wherein a weight ratio of the core material (that is, hard carbon) to the first ion-conducting modification layer (that is, sodium titanate) is approximately 100:5.

### Example 2

Example 2 used a preparation method similar to that of Example 1 to form sodium titanate as the first ion-conducting modification layer on a surface of the core material. However, formulas for preparing the sodium-containing precursor solution and the titanium-containing precursor solution of sodium titanate of Example 2 are as shown in Table 1, so that the weight ratio of the core material (that is, hard carbon) to the first ion-conducting modification layer (that is, sodium titanate) is approximately 100:2.5.

### Example 3

Example 3 used a preparation method similar to that of Example 1 to form sodium titanate as the first ion-conducting modification layer on the surface of the core material. However, formulas for preparing the sodium-containing precursor solution and the titanium-containing precursor solution of sodium titanate of Example 3 are as shown in Table 1, so that the weight ratio of the core material (that is, hard carbon) to the first ion-conducting modification layer (that is, sodium titanate) is approximately 100:1.

### Example 4

0.302 g of lithium acetate was dissolved in 15 ml of alcohol and 0.392 g of water was added to form a lithium-containing precursor solution. In addition, 1.690 g of butyl titanate was dissolved in 15 ml of alcohol to form the titanium-containing precursor solution. Powder of the active material for negative electrode (that is, the active material for negative electrode with the weight ratio of the core material to the first ion-conducting modification layer being 100:2.5) obtained in Example 2 was added to the titanium-containing precursor solution and uniformly stirred to form a third mixed solution. Then, the lithium-containing precursor solution was added to the third mixed solution and uniformly stirred to form a fourth mixed solution. Then, a solvent of the fourth mixed solution is removed by heating to obtain powder. Finally, the obtained powder was heated to 800° C. and calcined in an inert gas and kept at the temperature for 5 hours to obtain the active material for negative electrode (similar to as shown in FIG. 2A to FIG. 2C) with the hard carbon surface coated with sodium titanate (that is, the first ion-conducting modification layer) and lithium titanate (that is, the second ion-conducting modification layer), wherein the weight ratio of the core material (that is, hard carbon with an average particle size of approximately 10 μm) to the second ion-conducting modification layer (that is, lithium titanate) is approximately 100:2.5.

### Example 5

Example 5 used a preparation method similar to that of Example 4 to form lithium titanate as the second ion-conducting modification layer on a surface of the powder of the active material for negative electrode (that is, the active material for negative electrode with the weight ratio of the core material to the first ion-conducting modification layer being 100:1) of Example 3. However, formulas for preparing the lithium-containing precursor solution and the titanium-containing precursor solution of lithium titanate of Example 5 are as shown in Table 1, so that the weight ratio of the core material (that is, hard carbon) to the second ion-conducting modification layer (that is, lithium titanate) is approximately 100:1.

### Example 6

Example 6 used a preparation method similar to that of Example 1 to form sodium titanate as the first ion-conducting modification layer on the surface of the core material. However, formulas for preparing the sodium-containing precursor solution and the titanium-containing precursor solution of sodium titanate of Example 6 are as shown in Table 1, so that the weight ratio of the core material (that is, hard carbon) to the first ion-conducting modification layer (that is, sodium titanate) is approximately 100:0.5. Afterwards, a preparation method similar to that of Example 4 is then used to form lithium titanate as the second ion-conducting modification layer on the surface of the first ion-conducting modification layer. However, formulas for preparing the lithium-containing precursor solution and the titanium-containing precursor solution of lithium titanate of Example 6 are as shown in Table 1, so that the weight ratio of the core material (that is, hard carbon) to the second ion-conducting modification layer (that is, lithium titanate) is approximately 100:0.5.

TABLE 1

| | | | Example 1 | Example 2 | Example 3 | Example 4 | Example 5 | Example 6 |
|---|---|---|---|---|---|---|---|---|
| First ion- | Sodium- | Sodium | 0.571 | 0.286 | 0.114 | 0.286 | 0.114 | 0.056 |
| conducting | containing | acetate (g) | | | | | | |
| modification | precursor | Alcohol | 15 | 15 | 15 | 15 | 15 | 15 |
| layer | solution | (ml) | | | | | | |
| | | Water (g) | 0.716 | 0.358 | 0.143 | 0.358 | 0.143 | 0.072 |
| | Titanium- | Butyl | 3.382 | 1.690 | 0.676 | 1.690 | 0.676 | 0.338 |
| | containing | titanate (g) | | | | | | |
| | precursor | Alcohol | 15 | 15 | 15 | 15 | 15 | 15 |
| | solution | (ml) | | | | | | |
| Second ion- | Lithium- | Lithium | — | | | 0.302 | 0.121 | 0.061 |
| conducting | containing | acetate (g) | | | | | | |
| modification | precursor | Alcohol | — | | | 15 | 15 | 15 |
| layer | solution | (ml) | | | | | | |
| | | Water (g) | — | | | 0.392 | 0.157 | 0.079 |
| | Titanium- | Butyl | — | | | 1.852 | 0.741 | 0.371 |
| | containing | titanate (g) | | | | | | |
| | precursor | Alcohol | — | | | 15 | 15 | 15 |
| | solution | (ml) | | | | | | |

| | | | | | | | |
|---|---|---|---|---|---|---|---|
| Core material | Hard carbon (g) | 20 | 20 | 20 | 20 | 20 | 20 |

| | | | | | | |
|---|---|---|---|---|---|---|
| Weight ratio of core | 100:5 | 100:2.5 | 100:1 | 100:2.5 | 100:1 | 100:0.5 |
| material to first ion- | | | | | | |
| conducting | | | | | | |
| modification layer | | | | | | |
| Weight ratio of core | — | — | — | 100:2.5 | 100:1 | 100:0.5 |
| material to second ion- | | | | | | |
| conducting | | | | | | |
| modification layer | | | | | | |

### Comparative Example 1

Comparative Example 1 used a preparation method similar to that of Example 1 to form lithium titanate as the first ion-conducting modification layer on the surface of the core material, wherein formulas for preparing the lithium-containing precursor solution and the titanium-containing precursor solution of lithium titanate of Comparative Example 1 are the same as the formulas for preparing the lithium-containing precursor solution and the titanium-containing precursor solution of lithium titanate of Example 5 (as shown in Table 2), so that the weight ratio of the core material (that is, hard carbon with an average particle size of approximately 10 μm) to the first ion-conducting modification layer (that is, lithium titanate) is approximately 100:1. Afterwards, a preparation method similar to that of Example 4 was used to form sodium titanate as the second ion-conducting modification layer on the surface of the first ion-conducting modification layer. However, formulas for preparing the sodium-containing precursor solution and the titanium-containing precursor solution of sodium titanate of Comparative Example 1 are the same as the formulas for preparing the sodium-containing precursor solution and the titanium-containing precursor solution of sodium titanate of Example 5 (as shown in Table 2), so that the weight ratio of the core material (that is, hard carbon) to the second ion-conducting modification layer (that is, sodium titanate) is approximately 100:1.

### Comparative Example 2

The active material for negative electrode of Comparative Example 2 was hard carbon (with an average particle size of approximately 10 μm) and was not formed with any ion-conducting modification layer.

TABLE 2

| | | | Com- | Com- |
|---|---|---|---|---|
| | | | parative | parative |
| | | | Example | Example |
| | | | 1 | 2 |
| First ion- | Lithium- | Lithium | 0.121 | — |
| conducting | containing | acetate (g) | | |
| modification | precursor | Alcohol (ml) | 15 | — |
| layer | solution | Water (g) | 0.157 | — |
| | Titanium- | Butyl titanate | 0.741 | — |
| | containing | (g) | | |
| | precursor | Alcohol (ml) | 15 | — |
| | solution | | | |
| Second ion- | Sodium- | Sodium acetate | 0.114 | — |
| conducting | containing | (g) | | |
| modification | precursor | Alcohol (ml) | 15 | — |
| layer | solution | Water (g) | 0.143 | — |
| | Titanium- | Butyl titanate | 0.676 | — |
| | containing | (g) | | |
| | precursor | Alcohol (ml) | 15 | — |
| | solution | | | |

| | | | |
|---|---|---|---|
| Core | Hard carbon (g) | 20 | 20 |
| material | | | |

| | | |
|---|---|---|
| Weight ratio of core material to first | 100:1 | — |
| ion-conducting modification layer | | |
| Weight ratio of core material to second | 100:1 | — |
| ion-conducting modification layer | | |

The active materials for negative electrode of Example 1 to Example 6 and Comparative Example 1 and Comparative Example 2 above were respectively manufactured into half-cells by the following method and subjected to cycle life tests.

Manufacturing of half-cell: 93 parts by weight of the active material for negative electrode, 2 parts by weight of a conductive agent (for example, Super P, purchased from TIMCAL TIMREX), and 5 parts by weight of a binder (for example, PVDF, purchased from Solef) were uniformly mixed to form a slurry. Then, the slurry was coated on a copper substrate (that is, the negative electrode current collector) and dried. A rolling machine was used to roll the coating to 70% of the original thickness to obtain the negative electrode plate. The negative electrode plate was cut into a circular negative electrode plate with a diameter of 12 mm. The circular negative electrode plate, a sodium metal positive electrode plate, a polyethylene separator, and a commercial sodium ion battery liquid electrolyte were formed into a CR2032 half-cell.

Cycle life test: Between a cut-off voltage of 0.01 volt and a cut-off voltage of 2.5 volt, discharge in a constant current-constant voltage mode and charge in a constant current mode, the charging/discharging rate was 1C, the cycle life test was performed, and the irreversible rate of capacitance in the first cycle was calculated.

The test results of Experimental Example 1 to Experimental Example 3 and Experimental Example 8 are recorded in Table 3, and the test results of Experimental Example 4 to Experimental Example 7 are recorded in Table 4, wherein the half-cells of Experimental Example 1 to Experimental Example 6 respectively include the active materials for negative electrode of Example 1 to Example 6, and the half-cells of Experimental Example 7 and Experimental Example 8 respectively include the active materials for negative electrode of Comparative Example 1 and Comparative Example 2.

TABLE 3

| | Active | Irreversible | Retention rate of |
|---|---|---|---|
| | material | rate of | capacitance after 100 |
| | for negative | capacitance in | charging/discharging |
| | electrode | first cycle (%) | cycles (%) |
| Experimental | Example 1 | 27 | 96 |
| Example 1 | | | |
| Experimental | Example 2 | 27 | 94 |
| Example 2 | | | |
| Experimental | Example 3 | 28 | 95 |
| Example 3 | | | |
| Experimental | Comparative | 38 | 85 |
| Example 8 | Example 2 | | |

As shown in Table 3, since the active materials for negative electrode of Example 1 to Example 3 were provided with the first ion-conducting modification layers containing sodium titanate on hard carbon, the irreversible rates of capacitance in the first cycle of the half-cells of Experimental Example 1 to Experimental Example 3 were maintained below 30%, and at the same time, the retention rates of capacitance of the half-cells of Experimental Example 1 to Experimental Example 3 were still above 90% after 100 cycles of charging/discharging cycle tests, which had better cycle lives compared with Experimental Example 8 of Comparative Example 2 not formed with any first ion-conducting modification layer.

TABLE 4

| | Active material | Irreversible rate of | Capacitance |
|---|---|---|---|
| | for negative | capacitance in | at 100^{th} |
| | electrode | first cycle (%) | cycle (mAh/g) |
| Experimental | Example 4 | 27 | 224 |
| Example 4 | | | |
| Experimental | Example 5 | 28 | 249 |
| Example 5 | | | |
| Experimental | Example 6 | 26 | 257 |
| Example 6 | | | |
| Experimental | Comparative | 35 | 197 |
| Example 7 | Example 1 | | |

On the other hand, the active materials for negative electrode of Example 4 to Example 6 were provided with the first ion-conducting modification layers containing sodium titanate on hard carbon and were provided with the second ion-conducting modification layers containing lithium titanate on the surfaces of the first ion-conducting modification layers, so that the irreversible rates of capacitance in the first cycle of the half-cells of Experimental Example 4 to Experimental Example 6 were maintained below 30%, and at the same time, the capacitance at the 100^{th} cycles of the half-cells of Experimental Example 4 to Experimental Example 6 was still higher than 200 mAh/g. Experimental Example 7 included the active material for negative electrode of Comparative Example 1, which was provided with the first ion-conducting modification layer containing lithium titanate on hard carbon and was provided with the second ion-conducting modification layer containing sodium titanate on the surface of the first ion-conducting modification layer. Since the ability of sodium titanate to conduct sodium ions is worse than that of lithium titanate, if sodium titanate is used as the second ion-conducting modification layer, compared with using lithium titanate as the second ion-conducting modification layer (for example, Example 4 to Example 6), the sodium ions easily accumulate in the second ion-conducting modification layer and affect the smoothness of conduction of the sodium ions. Therefore, the electrical performance of the half-cell of Experimental Example 7 is poor.

In summary, the active material for negative electrode of the disclosure has the first ion-conducting modification layer or has the first ion-conducting modification layer and the second ion-conducting modification layer disposed on the surface of the core material, which can promote the diffusion of the sodium ions on the core material, while isolating the electrolyte from the core material, so that when the active material for negative electrode is subsequently applied to the negative electrode of the sodium ion battery, the side reaction of forming the solid electrolyte interface (SEI) during the charging/discharging process may be reduced and the consumption of the sodium ions in the electrolyte may be reduced, thereby improving the cycle life of the sodium ion battery.

It will be apparent to those skilled in the art that various modifications and variations may be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. An active material for a negative electrode, comprising:
a core material, wherein the core material is a carbon material; and
a first ion-conducting modification layer, disposed on a surface of the core material, wherein a material of the first ion-conducting modification layer comprises sodium titanium oxide.

2. The active material for the negative electrode according to claim 1, wherein the sodium titanium oxide comprises sodium titanate.

3. The active material for the negative electrode according to claim 1, wherein a weight ratio of the core material to the first ion-conducting modification layer is between 100:0.5 and 100:5.

4. The active material for the negative electrode according to claim 1, further comprising:
a second ion-conducting modification layer, disposed on a surface of the first ion-conducting modification layer, wherein the second ion-conducting modification layer comprises lithium titanium oxide.

5. The active material for the negative electrode according to claim 4, wherein the lithium titanium oxide comprises lithium titanate.

6. The active material for the negative electrode according to claim 4, wherein a weight ratio of the core material to the second ion-conducting modification layer is between 100:0.5 and 100:5.

7. The active material for the negative electrode according to claim 1, wherein the core material comprises hard carbon or soft carbon.

8. The active material for the negative electrode according to claim 1, wherein an average particle size of the core material is between 1 μm and 25 μm.

9. A sodium ion battery, comprising:
a negative electrode plate, comprising the active material for the negative electrode according to claim 1.

10. The sodium ion battery according to claim 9, further comprising:
a positive electrode plate, comprising an active material for a positive electrode, wherein the active material for the positive electrode comprises a layered metal oxide material, a Prussian blue series derivative, a natrium superionic conductor structural material, or a combination thereof.

11. The sodium ion battery according to claim 10, further comprising an electrolyte and a separator, wherein the separator, the negative electrode plate, and the positive electrode plate are disposed in the liquid electrolyte, and the separator is located between the negative electrode plate and the positive electrode plate.

12. The sodium ion battery according to claim 11, wherein a material of the liquid electrolyte comprises salt and a solvent, wherein the salt comprises sodium perchlorate, sodium fluoroborate, sodium hexafluorophosphate, sodium triflate, sodium bis(fluorosulfonyl)imide, sodium bistrifluoromethylsulfonimide, sodium difluorooxalate borate, sodium 4,5-dicyano-2-(trifluoromethyl)imidazolate, sodium 4,5-dicyano-2-(pentafluoroethyl)imidazolate, sodium bisoxalate borate, sodium bis[salicylato (2-)]-borate, sodium salicylic benzylic acid borate, sodium tetraphenyl borate, or a combination thereof.

13. The sodium ion battery according to claim 11, wherein a material of the separator comprises glass fiber, a polymer material, a ceramic material, or a combination thereof.
